(19) United States
(12) Patent Application Publication
(10) Pub. No.: US 2026/0057210 A1
(43) Pub. Date: Feb. 26, 2026

(54) CUMULANT-ENABLED MULTI-OMICS NEURAL NETWORK EMBEDDINGS

(71) Applicant: INTERNATIONAL BUSINESS MACHINES CORPORATION, ARMONK, NY (US)

(72) Inventors: ARITRA BOSE, Astoria, NY (US); ALDO GUZMAN SAENZ, White Plains, NY (US); Kahn Rhrissorrakrai, Middle Village, NY (US); Laxmi Parida, Mohegan Lake, NY (US)

(21) Appl. No.: 18/813,558

(22) Filed: Aug. 23, 2024

(51) Int. Cl. G06N 3/045

(52) U.S. Cl. CPC G06N 3/045

(57) ABSTRACT

According to one embodiment, a method, computer system, and computer program product for capturing higher-dimensional relationships between multimodal data features is provided. The present invention may include retrieving high-dimensional unlabeled multimodal data; processing the high-dimensional unlabeled multimodal data through a trained cumulant-enabled multi-omics neural network (CumiNN) to transform the high-dimensional unlabeled multimodal data into a lower-dimensional embedding; processing the lower-dimensional embedding further through the trained CumiNN to compute a plurality of synthetic representations of higher-order joint cumulants; and processing the plurality of synthetic representations of the higher-order joint cumulants further through the trained CumiNN to predict class labels of the higher-order joint cumulants.

### BACKGROUND

The present invention relates, generally, to the field of computing, and more particularly to computing higher-order joint cumulants using an artificial neural network.

Higher-order joint cumulants are important descriptors of complex properties in data distributions. Higher-order joint cumulants allow complex relationships between data features to be interpreted by providing information about the shape, asymmetry, and higher-order characteristics of the data. As a result, higher-order computations have widespread applications in different fields, such as biology, financial modeling, physical systems, signal processing, etc.

### SUMMARY

Embodiments of a method, a computer system, and a computer program product for capturing higher-dimensional relationships between multimodal data features are described. According to one embodiment, a method, computer system, and computer program product for capturing higher-dimensional relationships between multimodal data features may comprise retrieving high-dimensional unlabeled multimodal data; processing the high-dimensional unlabeled multimodal data through a trained cumulant-enabled multi-omics neural network (CumiNN) to transform the high-dimensional unlabeled multimodal data into a lower-dimensional embedding; processing the lower-dimensional embedding further through the trained CumiNN to compute a plurality of synthetic representations of higher-order joint cumulants; and processing the plurality of synthetic representations of the higher-order joint cumulants further through the trained CumiNN to predict class labels of the higher-order joint cumulants.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 is an operational flowchart illustrating a higher-order joint cumulant class label prediction process according to at least one embodiment.

FIG. 3 is an illustration of a higher-order joint cumulant class label prediction process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate generally to the field of computing, and in particular to computing higher-order joint cumulants using an artificial neural network. The present embodiment can capture higher-dimensional relationships between multimodal data features using a trained artificial neural network. More specifically, the present embodiment can transform multimodal data into lower-dimensional embeddings, compute higher-order joint cumulants from the low-dimensional embeddings of the multimodal data, and predict the class labels of the higher-order joint cumulants.

Higher-order joint cumulants may be higher-order moments and/or interactions between features, including multi-directional interactions between features. The cumulants of a probability distribution may be a set of quantities that provide an alternative(s) to moments of the probability distribution. Higher-order joint cumulants may be polynomial functions of the moments of the probability distribution and may cancel if they are only dependent on lower-order moments. The “order” in “higher order” may refer to the polynomial order of the joint cumulants. A joint cumulant of just one random feature may be its expected value, and that of two random features as their covariance. If some of the random features are independent of all the others, then any cumulant involving two or more independent random features may be zero. If all n random features are the same, the joint cumulant may be the n-th ordinary cumulant.

Currently, methods predict class labels of multimodal data using the data in its normal high-dimensional space. However, multimodal data comprises higher-order relationships among various features in the data. These higher-order relationships are difficult to capture due to their increasing computational complexity, thereby establishing an intractable problem. Therefore, an accelerated implementation of a higher-order joint cumulant class label prediction process is needed, in which higher-order joint cumulants are computed from lower-dimensional embeddings of the multimodal data and class label predictions are made on the higher-order joint cumulants.

Thus, embodiments of the present invention may provide advantages including, but not limited to, increasing the accuracy of predicted class labels of multimodal data. The present invention computes higher-order joint cumulants from lower-dimensional embeddings of multimodal data, thereby preserving the distance matrix between samples in the multimodal data and thus, capturing the higher-dimensional relationships between the data features. Also, the present invention predicts the class labels of the higher-order joint cumulants, thereby decreasing the presence of false positives in the class label predictions. The present invention does not require that all advantages need to be incorporated into every embodiment of the invention.

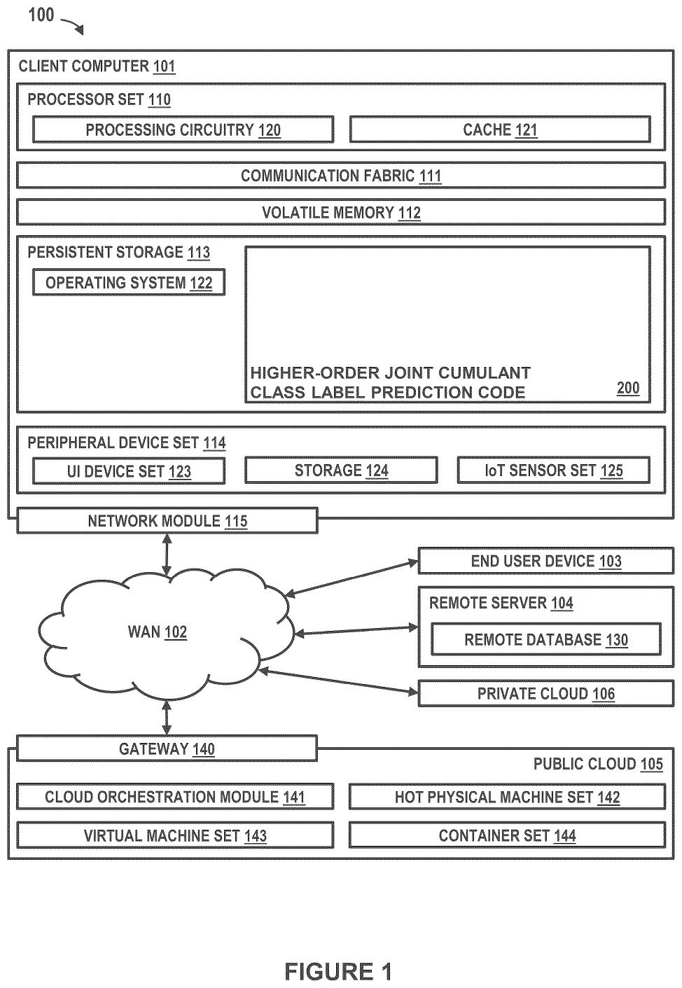

The embodiments mentioned in this paragraph are further illustrated and described below in the discussions of FIGS. 1, 2, and 3. According to at least one embodiment, the higher-order joint cumulant computation program retrieves high-dimensional unlabeled multimodal data. Also, the program processes the high-dimensional unlabeled multimodal data through a trained cumulant-enabled multi-omics neural network (CumiNN) to transform the high-dimensional unlabeled multimodal data into a lower-dimensional embedding. Furthermore, the program processes the lower-dimensional embedding further through the trained CumiNN to compute a plurality of synthetic representations of higher-order joint cumulants. Moreover, the program processes the plurality of synthetic representations of the higher-order joint cumulants further through the trained CumiNN to predict class labels of the higher-order joint cumulants.

According to at least one other embodiment, the program prepares multimodal sample data for use in training the CumiNN. According to at least one other embodiment, the program trains the CumiNN to predict class labels of higher-order joint cumulants using the prepared multimodal sample data. According to at least one other embodiment, the CumiNN comprises an embedding neural network and a classification neural network. According to at least one other embodiment, the program represents the predicted class labels in one or more generated formats. According to at least one other embodiment, the program displays the one or more generated formats.

According to at least one other embodiment, the plurality of synthetic representations of the higher-order joint cumulants comprise the higher-dimensional relationships between features of the high-dimensional unlabeled multimodal data. According to at least one other embodiment, training the CumiNN further comprises introducing a cross-entropy loss to the CumiNN through backward propagation. According to at least one other embodiment, training the CumiNN further comprises training and embedding neural network within the CumiNN to perform the transforming of the high-dimensional unlabeled multimodal data into the lower-dimensional embedding. According to at least one other embodiment, training the CumiNN further comprises training a classification neural network within the CumiNN to perform the predicting of the class labels of the higher-order joint cumulants.

The present invention may be a system, a method, and/or a computer program product at any possible technical detail level of integration. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The following described exemplary embodiments provide a system, method, and program product to retrieve high-dimensional unlabeled multimodal data, process the high-dimensional unlabeled multimodal data through a trained cumulant-enabled multi-omics neural network (CumiNN) to transform the high-dimensional unlabeled multimodal data into a lower-dimensional embedding, process the lower-dimensional embedding further through the trained CumiNN to compute a plurality of synthetic representations of higher-order joint cumulants, and process the plurality of synthetic representations of the higher-order joint cumulants further through the trained CumiNN to predict class labels of the higher-order joint cumulants.

Referring to FIG. 1, an exemplary networked computer environment 100 is depicted, according to at least one embodiment. Computing environment 100 contains an example of an environment for the execution of at least some of the computer code involved in performing the inventive methods, such as higher-order joint cumulant class label prediction code 200, also referred to as “higher-order joint cumulant class label prediction program 200”, or “the program 200”. In addition to code block 200 computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs, and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The database 130 may be a digital repository capable of data storage and data retrieval. The database 130 can be present in the remote server 104 and/or any other location in the network 102. The database 130 may comprise a knowledge corpus, whereby the knowledge corpus is maintained by the program 200. The knowledge corpus may store collected and organized multimodal sample data. The knowledge corpus can access one or more publicly available resources, such as, but not limited to, one or more clinical data repositories (“CDRs”) and financial data repositories (“FDRs”). The multimodal sample data can comprise visual, textual, and auditory data, as well as any other type of data represented as/in an image, continuous features, categorical data, quantitative data, or binary features. Also, the multimodal sample data can comprise various combinations of the types of data, such as multi-omics data. For example, multi-omics data may be epigenomic data sets, genomic data sets, metabolomic data sets, microbiome data sets, proteomic data sets, and/or transcriptomic data sets, amongst other data sets. The database 130 can store outputted data from an artificial neural network, such as predicted class labels and computed higher-order joint cumulants. Also, the database 130 can store training data, as well as store the trained artificial neural network.

The artificial neural network, herein referred to as the “Cumulant-Enabled Multi-Omics Neural Network” (“CumiNN”), may be a deep neural network. The CumiNN can be built in a number of programming languages, such as Python™ (Python™ and all Python™-based trademarks and logos are trademarks or registered trademarks of Python Software Foundation, and/or its affiliates) and/or Julia™ (Julia™ and all Julia™_based trademarks and logos are trademarks or registered trademarks of JULIAHUB Corporation, and/or its affiliates). Building the CumiNN in the Julia™ programming language enables the use of cumulant-generating functions through the implementation of one or more modules in the CumiNN, such as “Cumulants.jl”, “CumulantsFeature.jl”, “CumulantsUpdates.jl”, etc. In at least one embodiment, the CumiNN can be built in both Python™ and Julia™ programming languages, using a PyJulia module to call Julia™ directly from Python™, and using a PyCall interface to bridge both programming languages. At a minimum, the CumiNN can comprise an input layer, one or more hidden layers, an embedding neural network, a classification neural network, and an output layer. The embedding neural network can comprise one or more embedding layers. The classification neural network can comprise two layers. The first classification layer can comprise a layer that connects to the classification neural network input and multiplies the input data by a weight matrix, determined through a training process, and adds a bias vector. The second classification layer can comprise an output layer that computes a Softmax activation function on the output of the first classification layer and thus, produces the output of the classification network, i.e. predicts the class labels. Additionally, the CumiNN may comprise one or more skip connections between the layers in the CumiNN. The CumiNN may use skip connections to directly feed the output of one layer as input into a further layer.

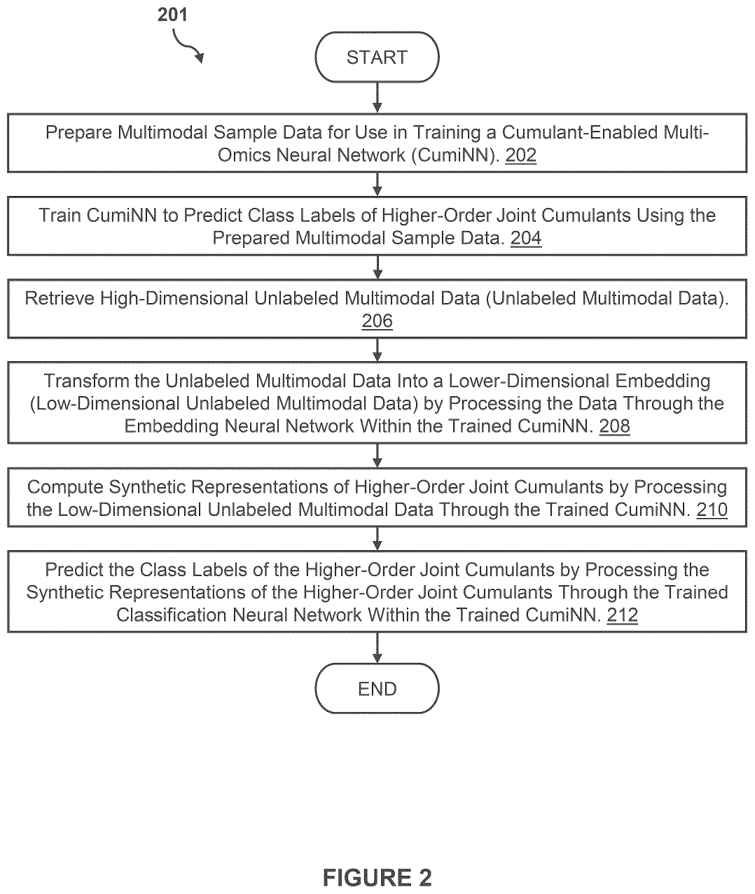

According to the present embodiment, the higher-order joint cumulant class label prediction program 200 may be a program capable of receiving high-dimensional unlabeled multimodal data. Also, the program 200 may be a program capable of processing the high-dimensional unlabeled multimodal data through a trained cumulant-enabled multi-omics neural network (CumiNN) to transform the high-dimensional unlabeled multimodal data into a lower-dimensional embedding. Additionally, the program 200 may be a program capable of processing the lower-dimensional embedding further through the trained CumiNN to compute a plurality of synthetic representations of higher-order joint cumulants. Moreover, the program 200 may be a program capable of processing the plurality of synthetic representations of the higher-order joint cumulants further through the trained CumiNN to predict class labels of the higher-order joint cumulants. The program 200 may be located on client computing device 101 or remote server 104 or on any other device located within network 102. Furthermore, the program 200 may be distributed in its operation over multiple devices, such as client computing device 101 and remote server 104. The higher-order joint cumulant class label prediction method is explained in further detail below with respect to FIG. 2.

Referring now to FIG. 2, an operational flowchart illustrating a higher-order joint cumulant class label prediction process 201 is depicted according to at least one embodiment. At 202, the program 200 prepares multimodal sample data for use in training the CumiNN. The program 200 can access and retrieve the multimodal sample data from the knowledge corpus within the database 130. The multimodal sample data may be high-dimensional, comprising feature vectors and their corresponding annotated ground truth labels, i.e. class labels. For example, feature vectors may represent multi-omics data. Also, for example, corresponding class labels, in binary or categorical form, may represent the data's characteristics/qualities, such as indicating a patient's disease status, disease subtype, height, blood pressure, etc. In at least one embodiment of the invention, the multimodal sample data may comprise learnable embeddings. The program 200 can randomly split the multimodal sample data into two groups, a training data group and a test data group. The training data group can comprise multimodal data, including their annotated class labels, that is used to train the CumiNN. The test data group can comprise multimodal data, excluding their annotated class labels, that is used to evaluate the performance of the CumiNN. The program 200 can aggregate the training data in the training data group to form a single, larger, training input data matrix. The training input data matrix, Xₜᵣₐᵢₙ, may be represented as:

$$[ \begin{matrix}{X}_{train} ∈ {ℝ}^{{m}_{1} \times n} \\ y ∈ {ℝ}^{{m}_{1}}\end{matrix} ]$$

The number of multimodal data samples in the training data group can be represented by m₁. The number of features, also referred to as variables, in the training data can be represented by n. The class labels can be represented by y. Additionally, the program 200 can aggregate the test data to form another single, larger, test input data matrix. The test input data matrix, Xₜₑₛₜ, can be represented as:

$$[ {X}_{test} ∈ {ℝ}^{{m}_{2} \times n} ]$$

The number of multimodal samples in the test data group can be represented by m₂. Thus, the sum of m₁ and m₂ equals the total number of samples in the multimodal sample data, m.

At 204, the program 200 trains the CumiNN to predict class labels of higher-order joint cumulants using the prepared multimodal sample data. Additionally, through the training process, the program 200 trains the CumiNN for transforming unlabeled multimodal data into a low-dimensional space and computing synthetic representations of higher-order joint cumulants using the low-dimensional embeddings. Unlabeled multimodal data may be multimodal data that does not comprise labels, classifications, and/or identifiers that indicate the data's characteristics/qualities. The program 200 can train the CumiNN, and both the embedding neural network and the classification neural network within the CumiNN, using feedforward propagation. The program 200 can separately feed the input data matrix, Xₜᵣₐᵢₙ, to the input layer of the embedding neural network and the input layer of the classification network within the CumiNN. The embedding neural network can be trained by learning lower-dimensional representations of the training input data. By learning the lower-dimensional representations of the training input data, the embedding neural network can be taught to transform high-dimensional input data into a low-dimensional space through an embedding process, while preserving the higher-order feature interactions in the high-dimensional input data. Thus, the embedding neural network can generate lower-dimensional representations of the high-dimensional input data, herein referred to as the low-dimensional input data. More specifically, as the training data passes through each embedding layer, the embedding neural network continuously reduces the number of features, n, comprised within the training input data by embedding the data features into a lower-dimensional network. The low-dimensional input data can comprise a number of embedded features, n_{emb}, whereby the number of embedded features, n_{emb}, is less than the number of features, n, in the training input data. The embedding neural network can aggregate the low-dimensional input data into a low-dimensional input data matrix, X_{emb}, represented as:

$$[ \begin{matrix}{X}_{e m b} ∈ {ℝ}^{{m}_{1} \times {n}_{e m b}} \\ {n}_{e m b} ≪ n\end{matrix} ]$$

Additionally, the CumiNN can be trained by learning synthetic representations of higher-order joint cumulants in a cumulant space using the low-dimensional input data matrix, X_{emb}. By learning synthetic representations of higher-order joint cumulants, the CumiNN can be taught to compute higher-order joint cumulants through the use of multiprocessing primitives, such as remote references and remote calls. The CumiNN can implement multiprocessing primitives using existing modules built into the Julia™ programming language. Specifically, the CumiNN can use the multiprocessing primitives to apply one or more cumulant generating functions to a low-dimensional input data matrix to generate a plurality of higher-order joint cumulants. The CumiNN can aggregate the plurality of higher-order joint cumulants to form a higher-order joint cumulant data matrix, X_{c}, represented as:

$$[ \begin{matrix}{X}_{c} ∈ {ℝ}^{{m}_{1} \times d} \\ d ≫ {n}_{e m b}\end{matrix} ]$$

The quantity of higher-order joint cumulants is represented by d, whereby the number of higher-order joint cumulant variables, d, is greater than the number of embedded features, n_{emb}, within the low-dimensional data matrix, X_{emb}. Although, the number of higher-order joint cumulant variables, d, is less than the number of features, n, within the input data matrix, Xₜᵣₐᵢₙ. In transforming the high-dimensional input data to lower-dimensional embeddings and computing higher-order joint cumulants from the lower-dimension embeddings, the CumiNN retains the higher-dimensional relationships between features of the unlabeled multimodal data within the synthetic representations of the higher-order joint cumulants.

The classification neural network can be trained by learning class labels of the multimodal sample using the input data matrix and the synthetic representations of higher-order joint cumulants. By learning the class labels of the multimodal sample, the classification neural network can be taught to predict the class labels of higher-order joint cumulants. Specifically, the classification network can be trained using the annotated training data within the input data matrix, Xₜᵣₐᵢₙ, to learn the class labels of multimodal data in a high-dimensional space. Additionally, the classification network can be trained using the higher-order joint cumulant data matrix, X_{c}, to learn the bijective mapping between the input data and the higher-order joint cumulant data. The classification neural network can aggregate predicted class labels into a predicted class label data matrix, y′, represented as:

$$[ {y}^{′} ∈ {ℝ}^{{m}_{2}} ]$$

Also, the classification neural network can be trained by implementing a cross-entropy loss function. The program 200 can compute the cross-entropy loss function by measuring the error between the probability distribution of the classification model and the probability distribution of the predicted values, i.e. the class labels, by the classification neural network, using the following binary cross-entropy formula:

$$L = - \frac{1}{N} [ {\sum }_{i = 1}^{N} [ {t}_{i} log ( {p}_{i} ) + ( 1 - {t}_{i} ) log ( 1 - {p}_{i} ) ] ]$$

The number of data points can be represented by N. The truth value taking a value of 0 or 1 can be represented by tᵢ. The Softmax probability for the i^{th} data point can be represented by pᵢ. The program 200 can introduce the cross-entropy loss to the classification neural network through backward propagation. During backward propagation, the program 200 adjusts the weights and biases of the layers, such that the cross-entropy loss function is minimized in each layer of the classification neural network.

Additionally, the training process can comprise the program 200 feeding the test input data matrix, Xₜₑₛₜ, to the embedding neural network to transform the test data into lower-dimensional embeddings. The CumiNN can compute synthetic representations of higher-order joint cumulants from the lower-dimensional embeddings of the test data. The CumiNN can feed the higher-order joint cumulants to the classification neural network to predict the class labels of the higher-order joint cumulants. The program 200 can evaluate the performance of the CumiNN by comparing the predicted class labels of the higher-order joint cumulants to the annotated class labels in the original sample multimodal data to obtain accuracy metrics.

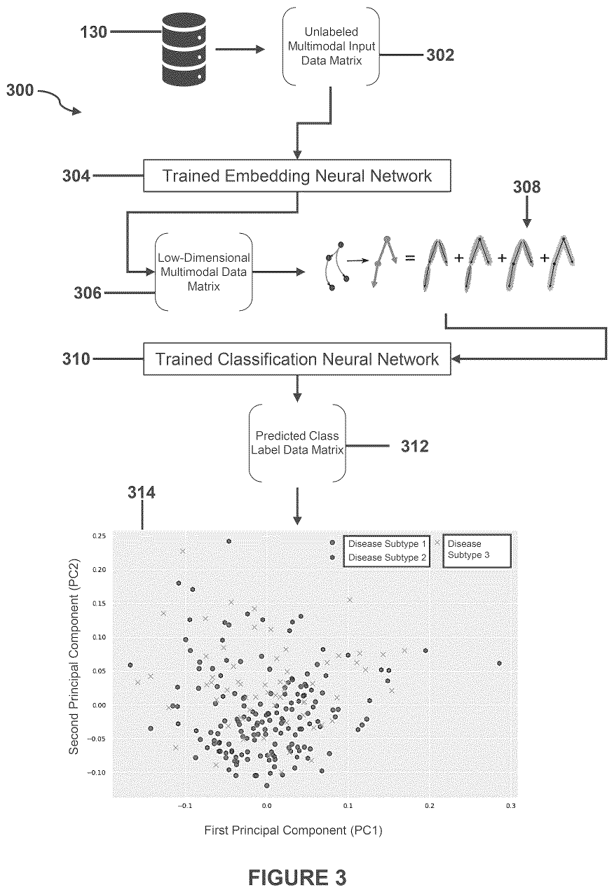

At 206, the program 200 retrieves high-dimensional unlabeled multimodal data. For example, the program 200 may retrieve high-dimensional unlabeled multi-omics data, such as patient, clinical, omics, and imaging data, from the database 130 (FIG. 3) whereby the multimodal data is stored, organized, and maintained. Also, for example, the program 200 may retrieve high-dimensional unlabeled financial data, such as market, economic, customer, news, social media, and risk data, from the database 130. The program 200 can aggregate the unlabeled multimodal data into an unlabeled multimodal input data matrix 302 (FIG. 3).

At 208, the program 200 transforms the high-dimensional unlabeled multimodal input data into a low-dimensional embedding, herein referred to as the low-dimensional unlabeled multimodal data, by processing the high-dimensional unlabeled multimodal data through the trained CumiNN's embedding neural network 304 (FIG. 3). The program 200 feeds the high-dimensional unlabeled multimodal input data matrix 302 to the input layer of the embedding neural network 304 within the trained CumiNN. As the embedding neural network processes the unlabeled multimodal input data matrix 302 through each of its embedding layers, the embedding neural network 304 continuously reduces the number of features comprised within the unlabeled multimodal input data matrix 302 as the unlabeled multimodal input data is mapped to a low-dimensional space. The number of embedded features in the unlabeled multimodal input data within the low-dimensional space is less than the number of features in the unlabeled multimodal input data within the high-dimensional space. By performing the embedding process in such a manner, the embedding neural network 304 preserves the pairwise distances between the features in the original high-dimensional unlabeled multimodal input data. The embedding neural network 304 can aggregate the low-dimensional unlabeled multimodal data into a low-dimensional unlabeled multimodal data matrix 306 (FIG. 3). The embedding neural network 304 can output the low-dimensional unlabeled multimodal data matrix 306.

At 210, the program 200 computes synthetic representations of higher-order joint cumulants 308 (FIG. 3) by processing the low-dimensional unlabeled multimodal data matrix 306 through the trained CumiNN. The trained CumiNN can apply one or more cumulant generating functions to the low-dimensional unlabeled multimodal data matrix 306 to generate a plurality of high-order joint cumulants 308. For example, the plurality of higher-order joint cumulants 308, as shown in FIG. 3, can be defined as:

$${μ}_{2 , 1}^{d i v} = {K}_{1}^{3} + {K}_{1} {K}_{1 , 1}^{d i v} + {K}_{2}^{c h a i n} {K}_{1} + {K}_{2 , 1}^{d i v}$$

The trained CumiNN can aggregate the plurality of higher-order joint cumulants 308 to form an unlabeled multimodal higher-order joint cumulant data matrix.

At 212, the program 200 predicts class labels of the higher-order joint cumulants by processing the synthetic representations of the higher-order joint cumulants 308 through the trained CumiNN's classification neural network 310 (FIG. 3). The program 200 feeds the unlabeled multimodal higher-order joint cumulant data matrix to the first layer of the classification neural network 310 within the trained CumiNN. The trained classification neural network 310 can multiply the unlabeled multimodal higher-order joint cumulant data matrix by a learned weight matrix, determined through the training process, in the first layer. Additionally, in the second layer, the classification neural network 310 can compute a Softmax activation function on the weighted unlabeled multimodal higher-order joint cumulant data matrix to predict the class labels of the unlabeled multimodal higher-order joint cumulant data matrix. The trained classification neural network 310 can aggregate the predicted class labels into a predicted class label data matrix 312 (FIG. 3). The classification neural network 310 may output the predicted class label data matrix 312. Additionally, in at least one embodiment, the CumiNN may represent the predicted class label data in one or more generated formats, such as a generated graphical format, for example, a scatter plot 314 (FIG. 3). The program 200 can display the predicted class label data itself 312 and the predicted class label data in the one or more formats 314 on one or more client computing devices 101 through a graphical user interface (“GUI”).

It may be appreciated that FIGS. 2 and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for capturing higher-dimensional relationships between multimodal data features, the method comprising:
retrieving high-dimensional unlabeled multimodal data;
processing the high-dimensional unlabeled multimodal data through a trained cumulant-enabled multi-omics neural network (CumiNN) to transform the high-dimensional unlabeled multimodal data into a lower-dimensional embedding;
processing the lower-dimensional embedding further through the trained CumiNN to compute a plurality of synthetic representations of higher-order joint cumulants; and
processing the plurality of synthetic representations of the higher-order joint cumulants further through the trained CumiNN to predict class labels of the higher-order joint cumulants.

2. The method of claim 1, the method further comprising:
preparing multimodal sample data for use in training the CumiNN; and
training the CumiNN for predicting class labels of higher-order joint cumulants using the prepared multimodal sample data.

3. The method of claim 1, wherein the CumiNN comprises an embedding neural network and a classification neural network.

4. The method of claim 1, the method further comprising:
representing the predicted class labels in one or more generated formats; and
displaying the one or more generated formats.

5. The method of claim 1, wherein the plurality of synthetic representations of the higher-order joint cumulants comprise the higher-dimensional relationships between features of the high-dimensional unlabeled multimodal data.

6. The method of claim 2, wherein training the CumiNN further comprises:
introducing a cross-entropy loss to the CumiNN through backward propagation.

7. The method of claim 2, wherein training the CumiNN further comprises:
training an embedding neural network within the CumiNN to perform the transforming of the high-dimensional unlabeled multimodal data into the lower-dimensional embedding; and
training a classification neural network within the CumiNN to perform the predicting of the class labels of the higher-order joint cumulants.

8. A computer system for capturing higher-dimensional relationships between multimodal data features, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
retrieving high-dimensional unlabeled multimodal data;
processing the high-dimensional unlabeled multimodal data through a trained cumulant-enabled multi-omics neural network (CumiNN) to transform the high-dimensional unlabeled multimodal data into a lower-dimensional embedding;
processing the lower-dimensional embedding further through the trained CumiNN to compute a plurality of synthetic representations of higher-order joint cumulants; and
processing the plurality of synthetic representations of the higher-order joint cumulants further through the trained CumiNN to predict class labels of the higher-order joint cumulants.

9. The computer system of claim 8, the method further comprising:
preparing multimodal sample data for use in training the CumiNN; and
training the CumiNN for predicting class labels of higher-order joint cumulants using the prepared multimodal sample data.

10. The computer system of claim 8, wherein the CumiNN comprises an embedding neural network and a classification neural network.

11. The computer system of claim 8, the method further comprising:
representing the predicted class labels in one or more generated formats; and
displaying the one or more generated formats.

12. The computer system of claim 8, wherein the plurality of synthetic representations of the higher-order joint cumulants comprise the higher-dimensional relationships between features of the high-dimensional unlabeled multimodal data.

13. The computer system of claim 9, wherein training the CumiNN further comprises:
introducing a cross-entropy loss to the CumiNN through backward propagation.

14. The computer system of claim 9, wherein training the CumiNN further comprises:
training an embedding neural network within the CumiNN to perform the transforming of the high-dimensional unlabeled multimodal data into the lower-dimensional embedding; and
training a classification neural network within the CumiNN to perform the predicting of the class labels of the higher-order joint cumulants.

15. A computer program product for capturing higher-dimensional relationships between multimodal data features, the computer program product comprising:
one or more computer-readable tangible storage medium and program instructions stored on at least one of the one or more tangible storage medium, the program instructions executable by a processor to cause the processor to perform a method comprising:
retrieving high-dimensional unlabeled multimodal data;
processing the high-dimensional unlabeled multimodal data through a trained cumulant-enabled multi-omics neural network (CumiNN) to transform the high-dimensional unlabeled multimodal data into a lower-dimensional embedding;
processing the lower-dimensional embedding further through the trained CumiNN to compute a plurality of synthetic representations of higher-order joint cumulants; and
processing the plurality of synthetic representations of the higher-order joint cumulants further through the trained CumiNN to predict class labels of the higher-order joint cumulants.

16. The computer program product of claim 15, the method further comprising:
preparing multimodal sample data for use in training the CumiNN; and
training the CumiNN for predicting class labels of higher-order joint cumulants using the prepared multimodal sample data.

17. The computer program product of claim 15, wherein the CumiNN comprises an embedding neural network and a classification neural network.

18. The computer program product of claim 15, the method further comprising:
representing the predicted class labels in one or more generated formats; and
displaying the one or more generated formats.

19. The computer program product of claim 15, wherein the plurality of synthetic representations of the higher-order joint cumulants comprise the higher-dimensional relationships between features of the high-dimensional unlabeled multimodal data.

20. The computer program product of claim 16, wherein training the CumiNN further comprises:
introducing a cross-entropy loss to the CumiNN through backward propagation.
